(19) United States
(12) Patent Application Publication
(10) Pub. No.: US 2017/0334393 A1
(43) Pub. Date: Nov. 23, 2017

(54) SECURING OF A MOTOR VEHICLE

(71) Applicant: ZF Friedrichshafen AG, FRIEDRICHSHAFEN (DE)

(72) Inventors: Mathias HÄUSLMANN, Amberg (DE); Josef HABENSCHADEN, Kohlberg (DE); Hans-Jürgen HANFT, Pegnitz (DE); Volker WAGNER, Ravensburg (DE); Roland FRIEDL, Auerbach (DE); Jörg KÜHNL, Weiherhammer (DE)

(73) Assignee: ZF Friedrichshafen AG, FRIEDRICHSHAFEN (DE)

(21) Appl. No.: 15/522,591

(22) PCT Filed: Oct. 20, 2015
(86) PCT No.: PCT/EP2015/074194

§ 371 Date: Apr. 27, 2017

(30) Foreign Application Priority Data
Nov. 20, 2014 (DE) 10 2014 223 739.4

(51) Int. Cl. B60R 25/06; B60R 25/04

(52) U.S. Cl. CPC B60R 25/06; B60R 2025/0405; B60R 2325/106

(57) ABSTRACT

A method for checking a motor vehicle comprises steps for transmitting an ID stored in an electronic control device of a transmission of the motor vehicle, to a central facility, the comparison on the part of the central facility of the ID with stored IDs assigned to specific motor vehicles, the transmission of a notification regarding the comparison result from the central facility to the control device, and the issuing on the part of the control device of a signal, if the ID has been located in the stored IDs. The communication comprises an authentication of the central facility thereby.

### BACKGROUND

### 1. Field of the Invention

The invention relates to a security system for a motor vehicle. In particular, the invention relates to protecting a motor vehicle against unauthorized use.

### 2. Background Information

A motor vehicle, in particular a passenger car, may represent considerable value, which should remain with the lawful owner through appropriate measures. In order to protect the motor vehicle against theft, an electronic immobilizer can be used, for example. Systems are also known for locating or decommissioning the motor vehicle if it has been stolen. These systems have proven to be not always reliable in practice.

US 2005/143883 A1 proposes establishing the identity of a motor vehicle on the basis of numerous data stored in different control devices of the motor vehicle. The registration or tracking of the motor vehicle should be more reliable as a result.

There is, however, furthermore the desire to create a better technology with which a motor vehicle can be protected. The invention solves this problem by means of a method, a computer program product and a control device having the features of the independent Claims. Dependent Claims describe preferred embodiments.

### BRIEF SUMMARY

A method for checking a motor vehicle comprises steps for transmitting an ID that is stored in an electronic control device of a transmission of the motor vehicle to a central facility, the comparison on the part of the central facility of the ID with stored IDs that are assigned to specific motor vehicles, the transmission of a notification of the results of the comparison from the central facility to the control device, and the issuing, on the part of the control device, of a signal, if the ID has been located in the stored IDs. The communication comprises an authentication of the central facility thereby.

A typical motor vehicle comprises a transmission, which is controlled by means of an electronic control device. By way of example, the control device can control procedures, such as shifting a gear setting. The transmission usually cannot be used without the control device. On the other hand, the lifetime of a typical transmission is long enough that it corresponds to that of the motor vehicle. The replacement of a transmission is a special case that normally never occurs with most motor vehicles. It has been noted the motor vehicle can be particularly efficiently protected via data stored in the control device of the transmission.

It has furthermore been proposed to carry out the comparison, of whether the ID of the control device indicates whether the motor vehicle is possibly not being operated legally, or there is another reason for issuing a warning or to limit said use, respectively, on the part of the central facility, which can be better protected against manipulation. In order to ensure that the comparison is not carried out by a third party, or that the communication between the control device and the central facility is not modified by a third party, the communication comprises at least an authentication by the central facility of the control device. The authentication preferably occurs in both directions, thus also of the central facility by the control device.

The communication of the control device with the central facility can occur, for example, in the framework of a typical servicing measure. The communication can also be wireless, without a driver of the motor vehicle taking action on it. The centralized comparison of the ID of the motor vehicle with the stored IDs can be sufficiently frequently carried out in this manner, in order to notice or prevent a misuse of a motor vehicle that has been reported stolen, for example.

It is preferred that the signal causes a decommissioning of the motor vehicle. The decommissioned motor vehicle preferably can no longer be moved on its axles, or with its own drive, such that further use can be prevented. This can make it easier to locate the motor vehicle.

The decommissioning preferably comprises a restricting of the gear steps that can be shifted to in the transmission. By way of example, the vehicle can only then be moved in first gear or in reverse. With an automatic transmission, the P setting can be locked, such that drive wheels of the motor vehicle are locked. The transmission can also comprise a controllable clutch, the engagement or disengagement of which can be prevented. As a result, there are different possibilities for flexibly restricting the availability of the motor vehicle.

In another embodiment, the signal is then also issued when the authentication fails. Thus, the attempt on the part of a third party to simulate the central facility can lead to an issuing of the signal. As a result, the security of the method can be improved.

In yet another embodiment, a characteristic of the motor vehicle is also transmitted to the central facility, wherein the transmitted characteristic is compared with a stored characteristic, which is assigned to the stored ID, and wherein the signal is issued if the transmitted characteristic differs from the stored characteristic.

By way of example, a vehicle identification number, a motor number, equipment characteristics or IDs that are stored in other control devices on board the motor vehicle can be transmitted to the central facility, and compared there with stored characteristics. In this manner, it can be prevented that the control device—if applicable, including the transmission—of a vehicle can continue to be operated on board another motor vehicle. The method can thus be better protected against attacks.

In another embodiment, the comparison results are transmitted from the central facility to the control device in any case, thus regardless of whether the comparison was positive or negative. In this case, the signal can then also be issued when the comparison result does not arrive at the control device until after a predetermined time. In other words, a time window can be defined, the start of which is determined, for example, with respect to the transmitting of the ID or with respect to the authentication, wherein the response on the part of the central party must reach the control device within the time window, in order to prevent the signal from being issued. A process that has been initiated can only be brought to an end in this manner without the signal being issued, when the comparison on the part of the central facility is negative. A locking of the transmission path from the central facility to the control device then can no longer leverage the method.

In one embodiment, the ID is formed on the basis of an identification of the motor vehicle. The ID of the motor vehicle can be determined, for example, during the production of the motor vehicle. Thus, the ID can be formed in the control device by means of an algorithm, wherein a direct linking to the motor vehicle and its characteristics can be established.

A computer program product comprises program codes for executing the described method, when the computer program product runs on a processor, or is stored on a computer readable data carrier.

An ID is stored in a control device for a transmission of a motor vehicle, wherein the control device is configured to check an authentication of a central facility, to transmit the ID to the central facility, if the authentication was successful, to receive a notification of the comparison result by the central facility, wherein the result relates to a comparison of the ID with stored IDs assigned to specific motor vehicles, and to issue a signal if the ID has been located in the stored IDs.

The control device can be developed in a simple manner from a known control device for the transmission. Protection against replacing the control device with a control device from another transmission can be carried out in the known manner.

It is preferred that the ID is stored in a protected area of the control device. In particular, it is preferred that the ID is stored in a memory area that can only be written on once. The memory area can offer space for numerous IDs, such that an updating of the ID—while keeping the original ID—is possible. Legitimate accesses to the control device, the transmission or the motor vehicle can be legitimized in this manner with respect to the control device, or the method described above, respectively.

### BRIEF DESCRIPTION OF THE DRAWINGS

The invention shall now be explained in greater detail with reference to the attached figures, in which:

FIG. 1 shows a system; and

FIG. 2 shows a flow chart for a method.

### DETAILED DESCRIPTION OF THE DRAWINGS AND THE PRESENTLY PREFERRED EMBODIMENTS

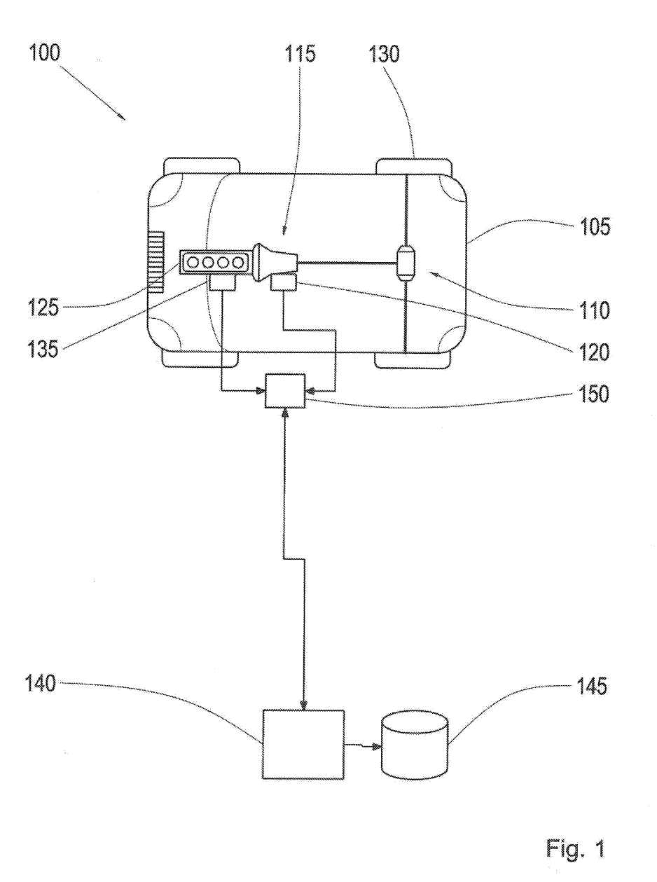

FIG. 1 shows a system 100 illustrating a technology for protecting a motor vehicle 105. The motor vehicle 105 comprises a drive train 110 having a transmission 115, which can be controlled by means of a control device 120. The drive train 110 normally leads from a drive motor 125 to a drive wheel 130 of the motor vehicle. The drive motor 125 can comprise an internal combustion engine, an electric motor, or a combination of multiple motors thereby.

The control device 120 is configured to control the transmission 115 on the basis of external specifications. In particular, the control device 120 can be configured to shift a gear step engaged in the transmission 115. The transmission 115 can also comprise a clutch, and the control device 120 can also control the clutch. In one embodiment, the transmission 115 comprises a double clutch that acts on two sub-transmissions. In another embodiment, the transmission 115 comprises a hydrodynamic torque converter that can be controlled by the control device 120.

The motor vehicle 105 can also comprise one or more other control devices 135. The control device 135 can be configured to provide an operating or equipment characteristic of the motor vehicle 105, or another ID of the motor vehicle 105.

The system 100 further comprises a central facility 140, which is preferably connected to a data base 145. The facility 140 is central in that it is configured to communicate with numerous motor vehicles 105, as shall be described more precisely below. In one embodiment, only one central facility 140 is provided for all of the motor vehicles 105 of a manufacturing line, a production line, a manufacturer, or a variation. In another embodiment, numerous facilities 140 may also be provided, that can either have equal rights, or can be subordinate to a higher order facility 140. In particular, the facilities 140 can be distributed geographically, in order to increase accessibility.

The facility 140 is configured to communicate with the control device 120, e.g. via a network such as Internet, or a dedicated network. A data connection between the motor vehicle 105 and the central facility 140 can be wireless, and periodically or permanently available. In another embodiment, the control device 120 can be connected for communication with a terminal 150, which can be connected to the motor vehicle 105 or the control device 120 for servicing purposes, for example. The terminal 150 can enable the input of data, such that an operator can manually input characteristics of the motor vehicle 105, for example, such as an auto body serial number, a motor serial number, a color or an equipment variation. Some of this data could additionally or alternatively be provided by the further control device 135. In another embodiment, the data from the further control device 135 can also be conveyed to the control device 120.

It has been proposed that a list be made on the part of the central facility 140, by means of which it can be checked whether the motor vehicle 105 has been reported stolen or not, for example. If this is the case, a suitable measure can be initiated on the part of the central facility 140 or on the part of the motor vehicle 105, in particular on the part of the control device 120. This measure can range from the issuing of a notification regarding the restriction of the functionality of a component of the motor vehicle 105 to a complete locking of one or more systems 100 of the motor vehicle 105. Furthermore, a visual, acoustic, or haptic alarm can be issued.

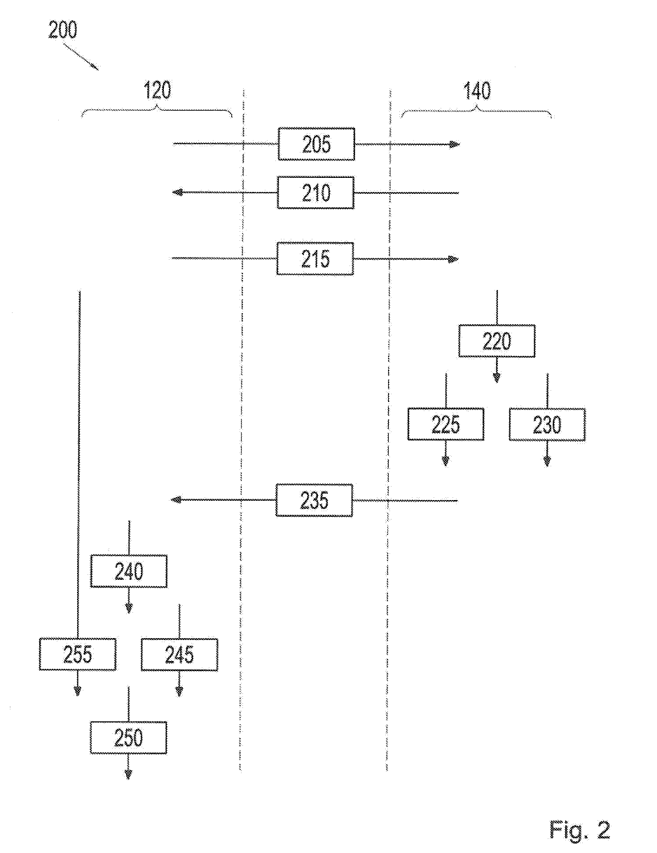

FIG. 2 shows a flow chart of a method 200 for protecting the motor vehicle 105 from FIG. 1. The illustration comprises notifications exchanged between the control device 120 of the transmission 115 on board the motor vehicle 105 and the central facility 140. Method steps that pertain to the control device 120 are thus depicted in a left-hand region, while method steps that pertain to the central facility 140 are depicted in the right-hand region. Notifications that are transmitted between the control device 120 and the central facility 140 are depicted between them. The method 200 is configured to check, on the part of the central facility 140, whether there is an objection to using, or to the availability of, the motor vehicle 105.

In a first step 205, the communication between the control device 120 and the central facility 140 is initiated. The initiation can, as described above, occur in different physical manners. The point in time for the initiation can depend on the physical connection. In a simple embodiment, a service is carried out on the motor vehicle 105, for which the terminal 150 is connected to the control device 120 in order to exchange data.

In step 210, the central facility 140 is authenticated to the control device 120. The control device 120 can be authenticated to the central facility 140 simultaneously thereby. Any of numerous known methods can be used for the authentication, such as those known, for example, in computer cryptography, and with the secured transmission of data in the Internet. Steps 205 and 210 can be implemented in different manners, and enable a data flow control between the control device 120 and the central facility 140, in order to enable the exchange of data, in particular encrypted data.

In step 215, an ID stored in the control device 120 is transmitted to the central facility 140. The ID can be established once, for example, in the framework of the manufacturing of the motor vehicle 105, i.e. after the transmission 115 and the control device 120 have been installed. The ID is preferably stored in a protected memory area of the control device 120, such that it is protected against unauthorized modifications.

Optionally, in step 215, another characteristic or further ID of the motor vehicle 105, or one of its elements, can be transmitted to the central facility 140.

In step 220, the ID received from the control device 120 is searched for in the data base 145. In a variation, the data base 145 only contains IDs that indicate a motor vehicle 105 for which there is an objection to their operation. By way of example, this can be a list of motor vehicles 105 that have been reported stolen.

In step 225, it is checked whether the received ID is located in the data base 145. If this is the case, then there is an objection to the use of the motor vehicle 105. In another embodiment, which can be combined with the last-specified embodiment, IDs of numerous motor vehicles 105 are stored in the data base 145, wherein one or more characteristics of the motor vehicle 105 are assigned to each stored ID. Preferably, a notification of the existence of an objection to the use of the motor vehicle 105, e.g. a theft report, is likewise assigned to the ID of the motor vehicle 105 as an entry in the data base 145. In step 230, one or more characteristics of the motor vehicle 105, which have been transmitted in step 215 to the central facility 140, are compared with stored characteristics. By way of example, these characteristics may include a vehicle identification number of the motor vehicle. If the received characteristic is not the same as the stored characteristic, then an objection can be raised against the use of the motor vehicle 105.

In step 235, the comparison result, or a notification regarding the comparison result, can be transmitted from the central facility 140 to the control device 120. This transmission preferably occurs in any case, i.e. both when there is an objection against the use, as well as when there is no objection.

The transmission of the notification in step 235 preferably occurs in an encrypted form. Is this case, the control device 120 decodes the received notification in step 240. If it is determined in step 245 that there is an objection to the use of the motor vehicle 105, then a corresponding signal is issued in step 250. The same signal can also be issued when it has been determined in an optional step 255 that the expected response by the central facility 140 from step 235 has not yet been received after one of the steps 205 to 215 for a longer period of time than a predefined time period. In this case, communication can be established with the central facility 140, but a response by the facility 140 may not have been received, which could be regarded as an indication that the communication has been manipulated.

The signal in step 250 can comprise a notification to a user or a service personnel of the motor vehicle 105 in an acoustic, visual or haptic form. The signal can, however, also concern the operation of the control device 120. In particular, the control device 120 can be caused, when the signal is issued in step 250, to restrict, in part or entirely, the operation of the motor vehicle 105.

### REFERENCE SYMBOLS

100 system
105 motor vehicle
110 drive train
115 transmission
120 control apparatus/control device
125 drive motor
130 drive wheel
135 further control device
140 central facility
145 data base
150 terminal
200 method
205 initiation of communication
210 authentication
215 transmission of ID, optionally, characteristics
220 search in data base
225 identification of a stolen motor vehicle?
230 reception of characteristic deviating from stored characteristic?
235 transmission of comparison result
240 decoding of comparison result
245 stolen
250 signal issued
255 no response

1. A method for checking a motor vehicle, the method comprising:
transmitting an identification, stored in an electronic control device of a transmission of the motor vehicle (105), to a central facility;
comparing the identification with stored identifications assigned to specific motor vehicles; wherein the comparing is conducted by the central facility;
transmitting a notification regarding the comparison result from the central facility to the electronic control device; and
issuing a signal from the electronic control device if the identification is located in the stored identifications;
wherein the transmitting of the identification comprises an authentication of the central facility.

2. The method of claim 1, wherein the issuing of the signal causes a decommissioning of the motor vehicle.

3. The method of claim 2, wherein the decommissioning comprises a restriction of the gear steps that can be engaged in the transmission of the motor vehicle.

4. The method of claim 1, wherein the issuing of the signal also occurs when the authentication fails.

5. The method of claim 1 further comprising:
transmitting a characteristic of the motor vehicle to the central facility;
comparing the transmitted characteristic with a stored characteristic assigned to the stored identification; and
issuing the signal if the transmitted characteristic differs from the stored characteristic.

6. The method of claim 1 further comprising:
transmitting a positive or negative comparison result from the central facility to the electronic control device; and
issuing the signal when the comparison result does not arrive at the electronic control device before a predetermined time period has elapsed.

7. The method of claim 1 further comprising:
forming the identification ID based on an identification of the motor vehicle.

8. A computer program product comprising:
programming code for executing transmission of an identification, stored in an electronic control device of a transmission of a motor vehicle, to a central facility; comparison of the identification with stored identifications assigned to specific motor vehicles; wherein the comparison is conducted by the central facility; transmission of a notification regarding the comparison result from the central facility to the electronic control device; and issuance of a signal from the electronic control device if the identification is located in the stored identifications; wherein the transmission of the identification comprises an authentication of the central facility;
wherein the computer program product runs on a processor or is stored on a computer-readable data carrier.

9. A control device for a transmission of a motor vehicle, the control device comprising:
an identification stored in the control device; wherein the control device is configured to check an authentication of a central facility; to transmit the identification to the central facility, if the authentication was successful; to receive a notification regarding a comparison result from the central facility; wherein the result relates to a comparison of the identification with stored identifications assigned to specific motor vehicles; and to issue a signal if the identification has been located in the stored identifications.

10. The control device of claim 9, wherein the identification is stored in an memory area of the control device that can only be written on once.

11. The method of claim 2, wherein the issuing of the signal also occurs when the authentication fails.

12. The method of claim 3, wherein the issuing of the signal also occurs when the authentication fails.

13. The method of claim 2 further comprising:
transmitting a characteristic of the motor vehicle to the central facility;
comparing the transmitted characteristic with a stored characteristic assigned to the stored identification; and
issuing the signal if the transmitted characteristic differs from the stored characteristic.

14. The method of claim 3 further comprising:
transmitting a characteristic of the motor vehicle to the central facility;
comparing the transmitted characteristic with a stored characteristic assigned to the stored identification; and
issuing the signal if the transmitted characteristic differs from the stored characteristic.

15. The method of claim 4 further comprising:
transmitting a characteristic of the motor vehicle to the central facility;
comparing the transmitted characteristic with a stored characteristic assigned to the stored identification; and
issuing the signal if the transmitted characteristic differs from the stored characteristic.

16. The method of claim 2 further comprising:
transmitting a positive or negative comparison result from the central facility to the electronic control device; and
issuing the signal when the comparison result does not arrive at the electronic control device before a predetermined time period has elapsed.

17. The method of claim 3 further comprising:
transmitting a positive or negative comparison result from the central facility to the electronic control device; and
issuing the signal when the comparison result does not arrive at the electronic control device before a predetermined time period has elapsed.

18. The method of claim 4 further comprising:
transmitting a positive or negative comparison result from the central facility to the electronic control device; and
issuing the signal when the comparison result does not arrive at the electronic control device before a predetermined time period has elapsed.

19. The method of claim 2 further comprising:
forming the identification based on an identification of the motor vehicle.

20. The method of claim 3 further comprising:
forming the identification based on an identification of the motor vehicle.
